(19) United States
(12) Patent Application Publication
(10) Pub. No.: US 2008/0168000 A1
(43) Pub. Date: Jul. 10, 2008

(54) Method for making a charitable donation

(76) Inventor: Deborah V. Dunn, Wayne, IL (US)

Correspondence Address: BRINKS HOFER GILSON & LIONE, P.O. BOX 10395, CHICAGO, IL, 60610, US

(21) Appl. No.: 11/650,741

(22) Filed: Jan. 8, 2007

(51) Int. Cl. G06Q 40/00

(52) U.S. Cl. 705/36 R

(57) ABSTRACT

Methods for funding a charity and passing assets to a beneficiary are disclosed. A modified charitable lead annuity trust is employed for these purposes. The modified CLAT is structured to make relatively small annual annuity payments to a designated charity as compared to the annual payments made to a charity under a traditional CLAT, as well as a relatively large back-end balloon or final annuity payment. A small portion of the trust assets are set aside to fund the small annual payment. The remainder of the trust assets is used to purchase a life insurance policy on the life of the grantor or other designated individual whose death will trigger the termination of the trust. The death benefit from the life insurance policy may be used to fund the final back-end balloon payment to the charity. Any excess death benefit may be distributed among the trust's remainder beneficiaries.

### BACKGROUND

1. Technical Field

The present invention relates to estate planning and charitable giving techniques. The techniques disclosed herein provide tax advantages that allow individuals to increase their charitable giving while passing on a greater portion of their assets to their heirs or other designated beneficiaries. An embodiment of the invention employs a modified charitable lead annuity trust (CLAT) as a mechanism for funding a specified charity and passing assets on to the trust remaindermen.

2. Background Information

In a traditional CLAT, a grantor contributes assets to the trust. At least a portion of the trust assets are invested in income-producing assets such as municipal bonds or the like, sufficient to support an annual fixed annuity payment to a designated charity. The annuity payments are paid to the charity each year for the life of the trust. If the trust is a grantor trust, the grantor may deduct the present value of the future payments to the charity from the grantor's income in the year in which the trust is funded. Any excess deduction may be carried forward up to five years. The present value of the charitable interest is calculated based on the amount of the payments and number of payments expected to be made to the charity over the life of the trust. If the trust is a non-grantor trust, the grantor may not take a charitable deduction on his or her personal income taxes based on the future payments to the charity. The trust, however, may deduct the annual payments to the charity as they occur. In either case, the trust may have a fixed term, or it may terminate upon some contingent event, such as at the death of the grantor. For a trust having a fixed term, the calculation of the present value of the future annual payments is relatively straightforward since the total number of payments to be paid to the charity is known in advance. If termination of the trust is based on a contingent event, however, it is necessary to estimate how many charitable payments will be made over the life of the trust. When a trust is structured to terminate at the death of the grantor (or the death of some other designated person) life expectancy tables such as IRS Table 90 CM may be consulted to estimate the total number of annual payments that will be made to the charity over the life of the trust.

Upon termination of the CLAT, the payments to the charity cease, and any assets remaining in the trust pass to the remainder beneficiaries, typically family members or other designated heirs. The amount of the remainder interest will depend on both the amount donated to the charity and the performance of the investments in which the trust assets are invested. In general, if the investments outperform the current applicable federal rate, there will be a larger remainder interest at the termination of the trust. The remainder interest, however, may be subject to gift taxes.

### BRIEF SUMMARY

The present invention employs a modified charitable lead annuity trust (a modified CLAT). In the modified CLAT, the annual annuity payments to a designated charity are reduced to a smaller amount than what is typically required in a traditional CLAT. In place of the larger annual payments, a large back-end balloon, or final annuity, is paid to the charity at the termination of the trust. A small portion of the trust assets may be set aside to fund the smaller annual payments. The remainder of the trust assets, however, may be used to purchase a life insurance policy on the life of the grantor or some other designated individual whose death will trigger the termination of the trust. The death benefit from the life insurance policy may be used to fund the final back-end balloon payment to the charity. Any excess death benefit may be distributed among the trust's remainder beneficiaries. There are no taxes on the growth of assets within the life insurance policy, nor on the death benefit. Accordingly, there are no ongoing tax liabilities for the trust.

According to an embodiment of the invention, a method for funding a charity is provided. The method includes establishing a modified CLAT structured to pay a relatively small annual annuity to the charity each year and a relatively large final annuity to the charity at the termination of the trust. The method further includes purchasing a life insurance policy on the life of a designated person upon whose death the trust will terminate. The life insurance policy provides a death benefit sufficient to cover the final annuity payment to the charity, with an additional balance that may be passed on to the trust beneficiary. Finally, the method includes paying the final annuity to the charity from the death benefit upon the death of the designated person.

Another embodiment provides a method for passing assets to a beneficiary. This embodiment includes transferring assets to a modified CLAT. The modified CLAT is structured to pay a relatively small annuity to a designated charity in each year of the trust's existence and a relatively large final annuity to the charity at the termination of the trust. The trust is structured to terminate on the death of a designated individual. A life insurance policy is purchased on the life of the designated person with a first portion of the trust assets. The life insurance policy includes a death benefit larger than the final annuity such that a portion of the death benefit may be used to pay the final annuity to the charity. The remainder may then be passed on to the beneficiary.

Finally, a method for calculating a current year charitable deduction is provided. The charitable deduction is based on a back-end balloon payment of a specified amount to be paid to a charity at an unknown time in the future. The back-end balloon payment is to be paid to the charity based on the occurrence of a contingent event. The method includes calculating a present value of the specified amount for each of a plurality of future years. Each of the present value calculations is based on the assumption that the specified amount will be paid to the charity in the corresponding year. Next, the method includes determining a probability that the back-end payment will be paid in each respective year. The probability is based on the likelihood of the contingent event occurring in each respective year. A contribution to the charitable deduction is calculated for each of the plurality of future years based on the present value of the specified amount, assuming it is paid in each respective year, and the probability that the back-end balloon payment will in fact be paid in the corresponding year. The total charitable deduction is calculated by summing the contributions from each respective year.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

FIG. 1 is a block diagram of a modified charitable lead annuity trust according to an embodiment of the invention.

FIG. 2 is a table listing the basic parameters of an example illustrating the operation of a modified charitable lead annuity trust according to an embodiment of the invention.

FIG. 3 is a first table illustrating the calculation of an income tax charitable deduction according to an embodiment of the invention.

FIG. 4 is a second table illustrating the calculation of an income tax charitable deduction according to an embodiment of the invention.

FIG. 5 is a flow chart showing a method of donating funds to a charity and passing assets to beneficiaries according to an embodiment of the invention.

### DETAILED DESCRIPTION OF THE DRAWINGS AND THE PRESENTLY PREFERRED EMBODIMENTS

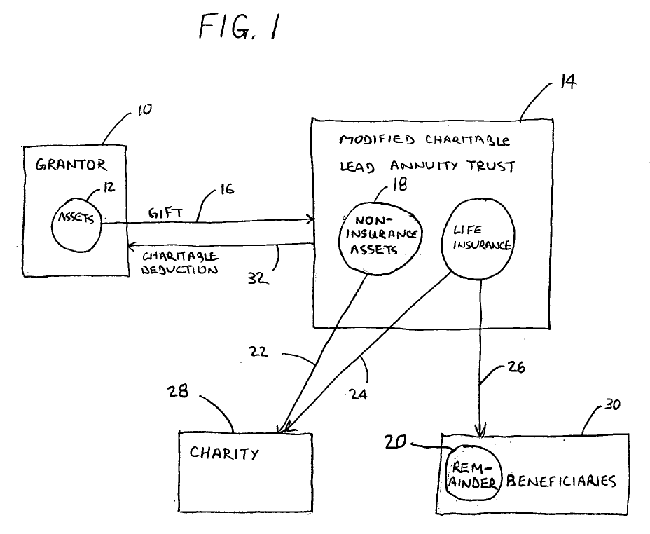

FIG. 1 is a block diagram showing the operation of a modified CLAT according to an embodiment of the invention. A grantor 10 controls a pool of assets 12. The grantor contributes the assets 12 to a modified CLAT 14 as indicated by the arrow 16. The modified CLAT 14 is structured to pay an annual annuity to a specified charity over the life of the trust, and a large back-end balloon or final annuity payment at the termination of the trust. The annual payment from the modified CLAT to the charity may be smaller than the annual payments made to a charity under a traditional CLAT. Within the modified CLAT 14 the assets are divided. A smaller portion 18 is set aside to purchase income generating assets to fund a smaller payment to a designated charity each year. The remainder 20 is used to purchase a single premium life insurance policy on the life of the grantor or other designated individual. (For the remainder of the present disclosure, it will be assumed that the modified CLAT will terminate on the death of the grantor and that the life insurance policy purchased with the trust assets will insure the life of the grantor, even though another individual could be designated if desired.) The annual annuity is paid to the charity 28 from the income earned on the portion of the trust assets 18 set aside for that purpose. Since the modified CLAT is structured to terminate upon the grantor's death, the life insurance death benefit will be paid at the same time the final annuity payment to the charity is due. Thus, when the grantor dies, the death benefit from the life insurance policy may be used to pay the back-end balloon payment to the charity 28, as indicated by the arrow 24. The remainder of the death benefit 20 in excess of the final annuity payment is paid to the remainder beneficiaries 30 as indicated by the arrow 26. Finally, the grantor may take a charitable deduction 32 on his or her income taxes for the year in which the modified CLAT is funded as indicated by the arrow 32. The size of the charitable deduction is based on the total amount that will be donated to the charity over the life of the trust, including the final annuity payment, and the grantor's life expectancy.

In order to calculate the grantor's charitable deduction, the total amount that will eventually be paid to the charity must be discounted to its present value for the year the trust is funded. The total amount that will be paid to the charity is equal to the annual annuity payment multiplied by the number of payments over the life of the trust plus the amount of the back-end balloon (the final annuity) payment. The number of annual payments that will be made to the charity over the life of the trust can be estimated based on the IRS life expectancy tables as with a traditional CLAT. However, while the amount of the back-end balloon is known in advance, it is not known when it will be paid. This uncertainty complicates the present value calculation.

Because it is not known when the final annuity will be paid, it is impossible to determine the amount by which the value of the future payment should be discounted in order to determine its present value. Therefore, the present invention encompasses a special algorithm for estimating the present value of the back-end balloon payment given the uncertainty as to when it will actually be paid. The algorithm is based on the size of the back-end balloon payment and the life expectancy of the grantor. Since we do not know how long the grantor will live, we cannot simply calculate the present value of the final payment using traditional discounting formulas. We can, however, calculate the present value of the balloon payment if we assume it is paid in a particular year. For example, if the grantor were to die in the third year of the trust, we can calculate the present value of the back-end balloon payment assuming it will be paid three years in the future. Similarly, we can calculate the present value of the back-end balloon payment if the grantor were to die in the fourth year, the fifth year, and so on. In fact, we can calculate the present value of the back-end balloon payment assuming it is paid in any particular year after the trust is established.

Furthermore, using IRS life expectancy tables, we can determine the probability that the grantor will die in any particular year after the trust is established. For example, IRS table 90 CM lists the probabilities of a person of a certain age X living a certain number of years Y into the future. These probabilities may be readily converted into values that indicate the probability that a person of a certain age X will die in any given year in the future. For purposes of calculating the charitable deduction associated with the back-end balloon payment, we perform multiple present value calculations to determine the present value of the balloon payment assuming it is paid in each year following the creation of the modified CLAT. In other words, we calculate the present value of the back-end balloon payment assuming it is paid in the first year after the modified CLAT is created, the second year, the third year, and so forth. The present value of the back-end balloon payment is calculated for every year after the trust is created for which there is a statistically meaningful probability that the grantor will survive. We also calculate the probability that the grantor will die in each subsequent year following the creation of the modified CLAT. A separate contribution to the grantor's present day charitable deduction is calculated for each year following the creation of the trust. Each year's contribution is based on the present value of the back-end balloon, assuming it is paid in that year, times the probability of the grantor dying in that particular year. The total charitable deduction is equal to the sum of each year's contribution. This algorithm may be expressed mathematically by the formula:

$$Charitable Deduction = {\sum }_{i = 1}^{M} ( {PV}_{i} ) \cdot ( {POD}_{i} )$$

### Where

PVᵢ is the present value of the back-end balloon paid in the year i;
PODᵢ is the grantor's probability of dying in the year i; and
M is a number of years beyond which there is essentially no chance that the grantor will survive.

By judiciously selecting the amount paid to the charity, it is possible to create a modified CLAT wherein the charitable deduction could be as high as 90% of the total amount contributed to the modified CLAT. Thus, the modified CLAT allows the grantor to receive a substantial current benefit in the form of a large income tax deduction. The charity receives a large future benefit, and the grantor's heirs or other specified beneficiaries receive a greater portion of the original assets than would otherwise have been the case.

The present technique may also be used as an alternative to buy-sell agreements, split-dollar life insurance arrangements, and other life insurance purchasing structures. If the grantor is married, the remainder interest could be further leveraged by purchasing a single life insurance policy on the grantor's life, with a death benefit equal to the amount of the balloon payment and for which the premium is less than the total amount of the trust corpus. The excess trust funds may be used to purchase a second-to-die policy on the lives of the grantor and the grantor's spouse. In general, it is possible to purchase more insurance in a second-to-die setting for the same premium than in a traditional policy. By purchasing a second-to-die policy, it may be possible to obtain an even larger benefit for the trust's remainder beneficiaries.

The benefits of employing the modified CLAT described above for making charitable contributions and passing assets to designated beneficiaries are best explained by way of example. Consider a 70-year-old woman with a large estate. Her assets include $1,100,000 in an Individual Retirement Account (IRA). Assume that the woman does not require the money in the IRA for her living expenses and that she desires to pass as much of it on to her children as possible. She is also interested in making a donation to a favored charity. Because of her large estate, her assets will be taxed at the maximum 45% estate tax rate when she dies. Should she die without liquidating the IRA, her estate will owe 35% in income tax on the $1,100,000 in the IRA and an additional 45% in estate taxes on the remaining value. In other words, if she does nothing with the IRA, she would only be able to pass on $393,250 of the $1,100,000 to her heirs after taxes. On the other hand, terminating the IRA today without taking further steps to shelter the tax-deferred income accumulated within the account would trigger a significant tax liability in the current year.

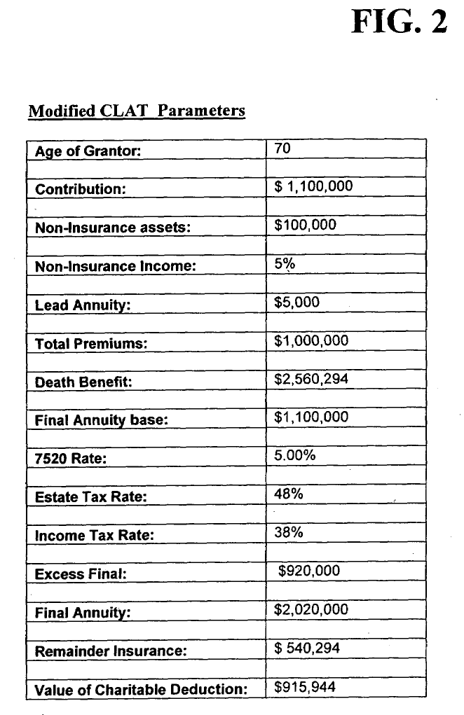

The solution is to create a charitable lead annuity trust as described above. The operation of the modified CLAT will depend on a number of factors summarized in the table of FIG. 2. The woman (the grantor) is 70-years-old. She contributes the entire value of her IRA, $1,100,000, to the trust. The modified CLAT is structured to pay a lead annuity of $5000 annually to a designated charity, and a final annuity (back-end balloon payment) of $2,0202,000 at the termination of the trust. The amount of the final annuity is selected to maximize the grantor's current year charitable deduction. A portion of the trust assets are to be invested in income-producing investments sufficient to cover the annual annuity payment to the charity. For purposes of the present example, we assume the invested assets will return 5% annually (non-insurance income). Similarly, we assume the applicable federal rate for discounting future payments (the 7520 rate) is also 5%. $100,000 invested at 5% in non-insurance investments will return the $5000 annually necessary to cover the yearly annuity payment to the charity. This leaves $1,000,000 of the trust corpus available to purchase a single premium life insurance policy on the grantor's life. According to insurance rates available at the time of this writing, a $1,000,000 premium will purchase a life insurance policy having a $2,560,294 death benefit for a 70-year-old woman. When the woman dies, the $2,560,294 death benefit will be used to pay the $2,020,000 final annuity to the charity, leaving a $540,294 remainder for the trust beneficiaries. Upon the woman's death, the $100,000 invested in non-insurance assets also passes to the beneficiaries. Thus, the trust beneficiaries will receive a total of $640,294, which amounts to $240,000 more than they would have received had the woman done nothing to protect the assets in the IRA account. Additional parameters listed in the table shown in FIG. 2 include the base final annuity $1,100,000, the excess final annuity $920,000, and the value of the grantor's charitable deduction $915,944. The significance of these values and how they are calculated will be described below.

We now turn to the manner in which the grantor's current year charitable deduction is calculated. As described above, the general process is to perform a separate present value calculation to determine what the present value of the final annuity payment would be if it were paid in each succeeding year after the formation of the modified CLAT and multiplying the present values by the probabilities that the woman will in fact die in each succeeding year. The result is a yearly contribution to the woman's current year income tax charitable deduction for each year in which the final annuity might be paid. Each succeeding year's contribution is weighted according to the probability that the woman will die in that particular year. The total charitable deduction is the sum of each weighted contribution.

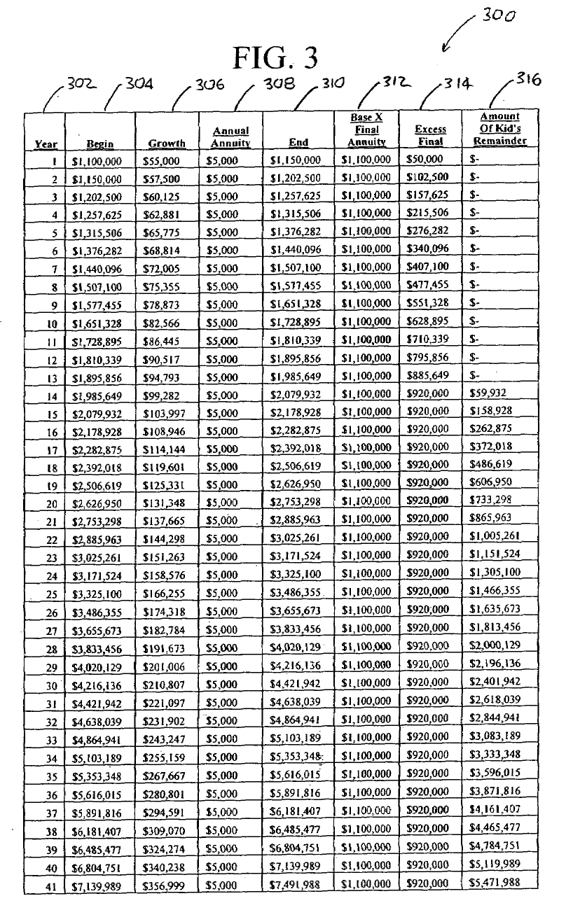

FIG. 3 is a spreadsheet that illustrates the present value calculations for determining the grantor's charitable deduction. While seemingly straightforward, the charitable deduction calculation described above is complicated by IRS accounting rules. In the present example, the $2,020,000 final annuity far exceeds the grantor's initial $1,100,00 contribution. Because the final annuity is backed by a life insurance policy on the grantor's life, the full amount of the final annuity will be paid to the charity regardless of the year in which the grantor dies. Even if the grantor dies in the first year after the trust is established, the charity will receive the full $2,020,000 final annuity, and the trust beneficiaries will receive the $540,294 balance of the $2,560,294 death benefit. According to the IRS, however, the grantor may not deduct more than she has actually contributed to the modified CLAT. Thus, for purposes of calculating the present value of the grantor's charitable gift, we must use the grantor's initial contribution ($1,100,000) as the “base final annuity” to be paid to the charity. The remaining $920,000 may be referred to as an “excess final annuity.” According the IRS rules, the base final annuity will grow each year at the “applicable federal rate” or the “7520 rate.” As mentioned above, the applicable federal rate has been defined as 5% for the present example. Thus, for purposes of calculating the grantor's current year charitable deduction, we may assume that the entire trust corpus, $1,100,000, will grow at 5% per year. For purposes of calculating the grantor's charitable deduction, the IRS assumes that the maximum charitable contribution the grantor will be able to make in any given year is the amount of the base final annuity, $1,100,000, plus its theoretical 5% annual growth. Only after trust assets have grown beyond the $920,000 “excess final annuity” may we deduct the present value of the entire $2,020,000 final annuity.

Turning to the table 300 shown in FIG. 3, each row corresponds to a particular year of the trust's existence. Column 302 numbers the years of the trust's existence. The column 304 shows the theoretical value of the trust assets at the beginning of each year. The Column 306 shows the expected growth of the trust assets over the course of the year based on the applicable federal rate (5%). Column 308 shows the value of the annuity payment ($5000) paid to the charity each year. Column 310 shows the theoretical end of year value of the trust assets. This value is derived from the beginning year balance from Column 304, plus the expected annual 5% growth from Column 306, minus the $5,000 annuity payment to the charity 308. Column 312 shows the base final annuity, $1,100,000 (i.e., the grantor's original contribution), and Column 314 shows the excess final annuity. The excess final annuity is the theoretical growth of the trust assets beyond the base final annuity that may be applied to the final annuity payment for purposes of calculating the grantor's charitable deduction. In the early years of the trust's existence, the annual growth of the trust assets is applied exclusively to the excess final annuity 314. Once the theoretical growth exceeds $920,000, however, the excess final annuity is capped, and the remainder is allocated to the heir's remainder interest, which is listed in column 316. The excess final annuity is capped at $920,000 since the base annuity, $1,100,000, plus $920,000, equals the full $2,020,000 final annuity, and $2,020,000 is the maximum amount that will be contributed to the charity regardless of future growth of the trust assets.

Looking at the numbers, the woman in our scenario contributes $1,100,000 to the trust in the first year. Thus, the beginning balance in year 1 is $1,100,000. At 5% , the expected growth of the trust assets during the first year is $55,000. $5,000 is paid to the charity to cover the annual annuity. Thus, the theoretical year-end value of the trust assets at the end of the first year is $1,150,000. The $1,150,000 year-end balance for the first year forms the beginning balance for the second year. This simple calculation is repeated for each subsequent year to determine the theoretical value of the trust assets, assuming a 5% annual growth rate each year.

As mentioned, column 312 of the table 300 shows the base annuity. Since the grantor makes but a single contribution, the base annuity does not change. It remains $1,100,000 for the life of the trust, and any growth is reflected in the excess final annuity or the heir's remainder interest in columns 314 and 316, respectively. The excess final annuity continues to grow in each of the first 13 years of the trust. Beginning in the fourteenth year the growth of the trust assets exceed $920,000, and the remaining growth is allocated to the heir's remainder interest. According to current IRS rules, the grantor may not claim a charitable donation in any given year that exceeds the theoretical value of the trust corpus, including the annual growth calculated based on the applicable federal rate. Thus, for each year in which the final annuity might be paid, the total charitable contribution will equal the base annuity plus the excess final annuity. If the final annuity is paid after the thirteenth year, the total charitable contribution that may be considered for calculating the grantor's current year charitable deduction will equal the full back-end balloon amount $2,020,000.

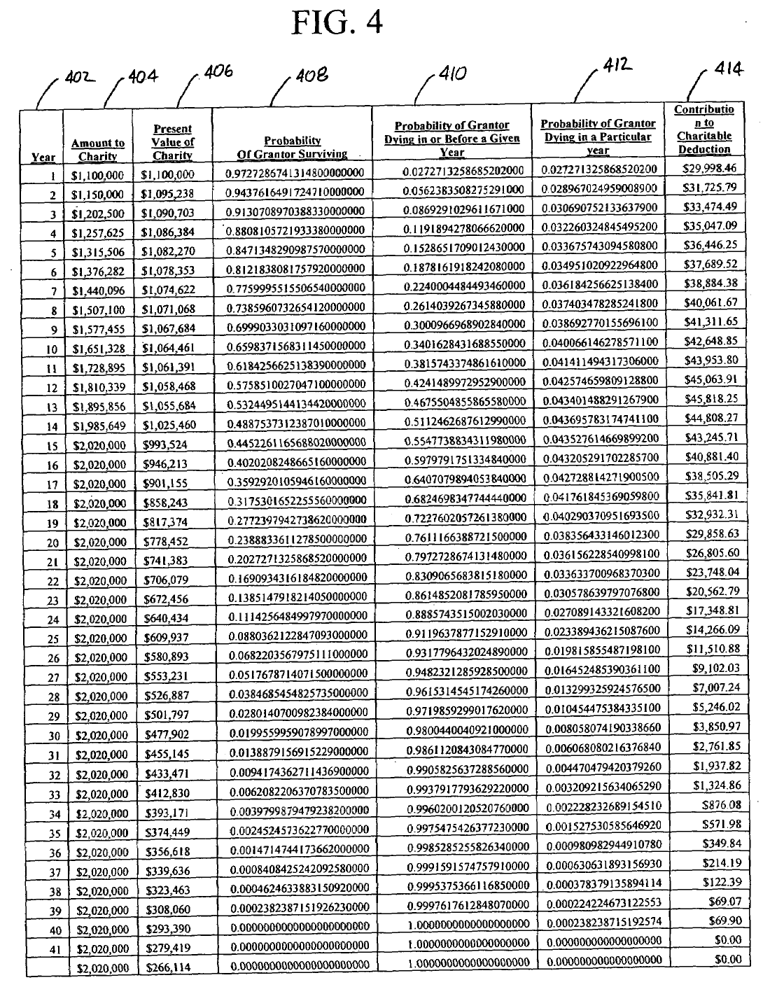

The table 400 in FIG. 4 is a continuation of the table 300 from FIG. 3. Again, each row corresponds to a succeeding year of the trust's existence. Column 402 identifies the year corresponding to each row. The second column 404 contains the theoretical amounts that may be donated to the charity each year based on the expected growth of the trust's assets. It should be noted that the full $2,020,000 final annuity will be paid to the charity regardless of which year it is paid. The theoretical amounts listed in Column 404 are used only for purposes of calculating the grantor's charitable deduction for the year in which the modified CLAT is funded. The theoretical amount to charity 404 is simply the base annuity 312 plus the excess final annuity 314 from table 300. Column 406 is the present value of the theoretical amount to charity from column 402 discounted by the applicable federal rate, 5% .

The next three columns, 408, 410 and 412 relate to the probabilities that the grantor will die in a particular year after the creation of the trust. The column 408 lists the probabilities of the grantor surviving through each successive year. These values are taken directly from the IRS life expectancy table 90 CM. Recall that in the present example the grantor is a 70-year-old woman. According to the IRS life expectancy tables, the probability of a 70-year-old woman surviving one more year is 0.97272867413148. The probability of a 70-year-old woman surviving two more years is 0.943761649172971, and so forth. The probability that a 70-year-old woman will survive 39 more years drops to 0.000238238715192623, and the probability of a 70-year-old woman surviving past 39 more years is essentially zero; thus our calculations need not proceed beyond 39 years.

Column 410 shows the converse of column 408, namely the probability that the woman will die before the end of each successive year. The probability of dying values in column 410 are derived by simply subtracting the probability of surviving values of column 408 from the number 1. Thus, a person having a 0.95 probability of surviving through the fifth year, would have a 1−0.95 or 0.05 probability of dying in the fifth year or sooner. Column 412 shows the incremental increase in the probability of the woman dying in each successive year. The values in column 412 are calculated by subtracting the previous year's probability of dying (column 410) from the present year's probability of dying. For example, the probability of the woman dying before the end of the first year is 0.0272713258685202. The probability of the woman dying before the end of the second year is 0.0562383508275291. Thus, the incremental difference between the probability that the woman will die before the end of the first year and the probability that the woman will die before the end of the second year (0.0562783508275291−0.02727132−58585202=0.0289670249590089) is the probability that the woman will actually die in the second year after the trust is created.

Recall that according to the invention, the grantor's charitable deduction is calculated by summing a plurality of weighted contributions calculated for each possible year of the trust's existence. The weighted contributions for each year are determined by calculating the present value of the theoretical amount that would be paid to the charity if the woman died in a particular year, and multiplying the present value by the probability that the woman will in fact die in the particular year in question. The weighted contributions for each year are listed in column 414.

The first year's contribution to the woman's current year charitable deduction is $22,998.46 ($1,100,000×0.02727132586852022). The second year's contribution is $31,725.79 (1,095,238×0.0289670249590089), the third year's is $33,474.49 (1,090,703×0.0306907521336379), and so forth. Over time, as the probability of the woman surviving each additional year diminishes, the amount of each year's contribution diminishes as well. Eventually, when there is virtually no chance of the woman surviving another year, the contribution from succeeding years becomes zero. Summing the values in column 414 results in a total charitable deduction of $915,944. Thus, for the year in which the woman liquidates her IRA account to fund the trust, she will be allowed to deduct $915,944 from her gross income. In other words, she will be required to pay income tax on only $184,056 of the total $1,100,000 in her IRA account, resulting in a significant tax savings.

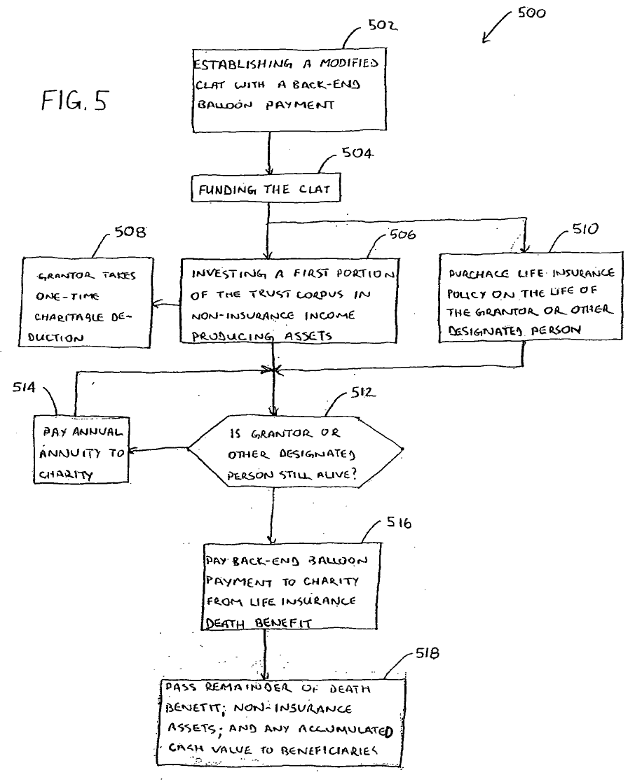

Finally, an embodiment of the invention encompasses a method for donating funds to a charity and passing assets to heirs having advantageous tax consequences. A flow chart 500 is shown in FIG. 5 illustrating the inventive method. A first step 502 is to create a modified charitable lead annuity trust (modified CLAT) as described above. The modified CLAT is structured to pay a relatively small annual fee to a charitable organization of the grantor's choosing. In this case, the annual fee paid to the charity is small relative to the annual payments made to a designated charity under a traditional CLAT. Further, the trust is structured to pay a specified back-end balloon payment (final annuity) to the charity at the termination of the trust (typically the death of the grantor). At 504 the grantor transfers assets to the trust. The grantor then takes a one-time charitable deduction on his or her income taxes at 508. The amount of the charitable deduction will be based on the present value of the smaller payments made to the charity each year, the grantor's life expectancy, the present value of the back-end balloon payment, and the likelihood that it will be paid in each successive year following the creation of the trust.

At 506 a portion of the trust assets are invested in income-generating investments sufficient to fund the annual lead annuity payment to the charity. The remainder of the trust assets is used to purchase a life insurance policy at 510, typically on the grantor's life. At 512 it is determined whether the grantor (or other designated individual whose death will terminate the trust) is still alive. So long as the grantor or other such person is still alive, the annual payment is made to the charity at 514. If the grantor or other designated person dies, the back-end balloon payment is paid to the charity from the death benefit of the life insurance policy at 516. The remainder of the death benefit is passed on to the trust's remainder beneficiaries at 518.

Under current tax laws at the time of this writing, the death benefit paid to the trust beneficiaries is not subject to estate taxes. Accordingly, there are distinct advantages to employing a modified CLAT according to the method illustrated in FIG. 5. First, the grantor receives a considerable tax deduction in the year in which he or she funds the trust (any unused deduction may be carried forward for up to five years). Second, the grantor is able to make a significant donation to a charity of his or her choice, satisfying the grantor's philanthropic impulses and benefiting the charity. Finally, the grantor is able to pass a much larger portion of the trust assets to his or her heirs than would have otherwise been the case if the grantor had employed more traditional methods.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method of funding a charity comprising:
establishing a modified charitable lead annuity trust structured to pay a relatively small annual annuity to the charity each year and a relatively large final annuity to the charity at the termination of the trust;
purchasing a life insurance policy on the life of a designated person whose death will terminate the trust, the life insurance policy having a death benefit; and
paying the final annuity to the charity from the death benefit upon the death of the designated person.

2. The method of claim 1 further comprising receiving trust assets from a grantor.

3. The method of claim 2 further comprising purchasing non-insurance assets generating income sufficient to pay the annual annuity with a portion of the trust assets.

4. The method of claim 2 wherein purchasing a life insurance policy on the life of a designated person whose death will terminate the trust comprises purchasing a single premium life insurance policy on the life of the grantor from a portion of the trust assets.

5. The method of claim 1 wherein the death benefit is greater than the final annuity, the method further comprising paying a balance of the death benefit to designated trust beneficiaries after the final annuity has been paid to the charity.

6. A method of passing assets to a beneficiary comprising:
transferring assets to a modified charitable lead annuity trust structured to pay a relatively small annuity to a designated charity in each year of the trust's existence, and structured to pay a relatively large final annuity to the charity at the termination of the trust, the trust terminating on the death of a designated individual; and
purchasing a life insurance policy on the life of the designated person with a first portion of the assets transferred to the trust, the life insurance policy providing a death benefit larger than the final annuity such that a portion of the death benefit may be used to pay the final annuity to the charity, and a remainder may be passed on to the beneficiary.

7. The method of claim 6 further comprising purchasing income-generating assets with a second portion of the assets transferred to the trust, the income-generating assets generating sufficient income to pay the relatively small annuity to the designated charity each year.

8. The method of claim 6 wherein the designated individual is a grantor responsible for transferring the assets to the modified charitable lead annuity trust.

9. The method of claim 8 further comprising calculating a charitable deduction to be taken on the grantor's income taxes in the year in which the grantor transfers the assets to the trust.

10. The method of claim 9 wherein the charitable deduction is calculated based on a present value of the final annuity and the life expectancy of the grantor.

11. The method of claim 9 wherein the charitable deduction is calculated based on a contribution from each year in a plurality of future years in which the final annuity might be paid.

12. The method of claim 11 wherein each year's contribution is based on the present value of the final annuity if the final annuity were to be paid in the corresponding year.

13. The method of claim 11 wherein each year's contribution is based on the probability that the final annuity will be paid in each respective year.

14. The method of claim 6 wherein purchasing a life insurance policy on the life of the designated person with a first portion of the trust assets comprises purchasing a single premium life insurance policy having a death benefit sufficient to pay the final annuity to the charity with little or no remainder, the method further comprising purchasing a second-to-die life insurance policy on the designated person an a second designated person with a second portion of the assets transferred to the trust, the second-to-die policy having a death benefit that will be paid to the beneficiaries when the second of the designated person and the second designated person dies.

15. A method of calculating a current year charitable deduction for a back-end balloon payment of a specified amount to be paid to a charity at an unknown time in the future based on the occurrence of a contingent event, the method comprising:
calculating a present value of the specified amount for each of a plurality of future years, assuming that the specified amount is paid to the charity in each respective year;
determining a probability that the back-end payment will be paid in each respective year based on the likelihood of the contingent event occurring in each respective year;
calculating a contribution to the charitable deduction from each of the plurality of future years based on a present value of the specified amount calculated for each respective year and a probability that the back-end balloon payment will be paid in each respective year; and
summing the contributions from each respective year.

16. The method of claim 15 wherein the back-end balloon is to be paid from a death benefit of a life insurance policy, and the contingent event is the death of an individual insured by the life insurance policy.

17. The method of claim 16 wherein the probability that the back-end balloon payment will be paid in each respective year is based on a life expectancy of the individual insured by the life insurance policy.

18. The method of claim 17 wherein the life expectancy of the individual insured by the life insurance policy is determined according to the Internal Revenue Service life expectancy table 90 CM.

19. The method of claim 15 wherein the specified amount of the back-end balloon payment is equal to a base amount times an annual growth rate.

20. The method of claim 15 wherein the present of the specified amount is the specified amount discounted according to the applicable federal rate.
